(19) United States
(12) Patent Application Publication
(10) Pub. No.: US 2022/0304343 A1
(43) Pub. Date: Sep. 29, 2022

(54) A METHOD FOR CONSERVING COOKED FOOD PRODUCTS

(71) Applicant: UNOX S.P.A., CADONEGHE (PD) (IT)

(72) Inventors: Enrico FRANZOLIN, CADONEGHE (PD) (IT); Luciano BELLEMO, NOVENTA PADOVANA (PD) (IT)

(73) Assignee: UNOX S.P.A., CADONEGHE (PD) (IT)

(21) Appl. No.: 17/641,970

(22) PCT Filed: Sep. 3, 2020
(86) PCT No.: PCT/IB2020/058206

§ 371 Date: Mar. 10, 2022

(30) Foreign Application Priority Data
Sep. 13, 2019 (IT) 102019000016280

(51) Int. Cl. A23L 3/3418; A23L 3/015

(52) U.S. Cl. CPC A23L 3/3418; A23L 3/0155

(57) ABSTRACT

In a method for conserving cooked food products, the food products are contained inside conservation containers having a total volume which is partially occupied by the food product and partially occupied by air in contact with the food product. The method includes reducing the oxygen concentration in a container which contains the food product by application of a reduced pressure generated by an ejector device which operates with compressed air so as to bring the oxygen concentration to values below 10%, within a duration time including a first time period in which the pressure in the container is brought to a value equal to the vapor pressure of the water contained in the food product and corresponding to the temperature of the food product and maintaining this condition for a second successive time period so as to reach the oxygen concentration below 10%.

### TECHNICAL FIELD

The present invention relates to a method for conserving cooked food products.

### TECHNOLOGICAL BACKGROUND

The invention relates to the specific field of conserving over time food products and foodstuffs which have been subjected to cooking and particularly, though in a non-exclusive manner, relates to the processes of conserving food products which are prepared in domestic kitchens and particularly professional kitchens, in the last case of the type used in mass catering establishments, such as, for example, restaurants, canteens and the like, supermarkets, catering facilities, military catering, etc.

In this context, the problem of conservation of the cooked food products is a particularly important topic.

Currently cooked food can be conserved for several hours or several days or up to several weeks or months, and this depends particularly on the type of food and the conservation technology used.

It must be borne in mind that the cooked food product to be conserved may be of different types, for example, it may be a soup or thick soup, a roast, stewed meat, sauce or it may comprise more complex preparations with a plurality of ingredients.

There are known two main methods which are used to conserve cooked food products: “in the cold state” and “in the hot state”.

The present invention makes reference to conservation of the cooked food products in the hot state, wherein the cooked food products are conserved for times greater than several hours, in particular for times greater than four hours. It is directed towards a method and a system for conservation in which there is provision for reduced pressure to be applied, and it is configured to allows problems and limitations of the currently known methods and systems used in kitchens to be overcome.

During hot conservation of cooked food products in the hot state, the main cause which limits the conservation time to approximately four hours is the oxidation of the food in the conservation unit caused by the oxygen in the air.

There is known a method which is described in EP3030095 which also teaches to conserve the cooked food product for several days by reducing the partial pressure of the oxygen in contact with the cooked food product below a specific value and by maintaining the food product at a temperature greater than 58° C.

In order to reduce the partial pressure of the oxygen in contact with the cooked food product, it is possible to use a number of techniques, for example:
a) replacing air and therefore oxygen with an inert gas, such as nitrogen or argon,
b) eliminating the air and therefore the oxygen by reducing the pressure.

The invention makes reference to this second methodology which provides for the use of reduced pressure.

In order to be able to conserve the cooked food product at temperatures greater than 58° C. for several hours and up to several days (for example, a week), it is necessary to reduce the partial pressure of the oxygen and therefore the volumetric percentage thereof (%) to very low values. For example, from approximately 21% which is the volumetric concentration of oxygen which there is in air to values which can vary from 0.01% to 10%. The range is quite wide because the maximum values (the term “maximum values” being intended to be understood to be the values above which the conservation of the food product at a predetermined temperature and for a specific time leads to organoleptic characteristics which are unacceptable) of partial pressure of the oxygen are highly influenced by the type of food product which is intended to be conserved, the conservation temperature and the number of hours or days which it is desirable to conserve the food product for. Generally, in any case, the volumetric percentage (%) of oxygen has to be closer to the low values (for example, 0.1%) than high ones (for example, from 3% to 10%).

Generally, it is further quite difficult to measure the volumetric percentage of oxygen which remains in contact with the food product after the application of the reduced pressure. It may be considered, however, that if a predetermined reduced pressure generation process is used, the oxygen concentration which is obtained at the end of this process is always the same. The term “predetermined reduced pressure generation process” is intended to be understood to mean a process which allows the production of a predetermined degree of pressure reduction applied for a predetermined period of time, in relation to a predetermined food product (quality, quantity) which is placed in a predetermined container at a predetermined temperature. For this reason, it is possible to evaluate by experiment with sensory analysis tests (for example, with the so-called “panel test” or other methods which are well known in literature) the result of the conservation of the food product by comparing the organoleptic characteristics of the food product which has just been cooked with those of the food product which is conserved in the hot state and therefore to select the optimum reduced pressure generation process for a predetermined type of food product and the time and the temperature of conservation, and in particular to select the degree of pressure reduction and the reduced pressure application time.

Furthermore, the cooked food product can generally be conserved in two different main manners which depend on the type of container used for the cooking.

In a first method, the container is constituted by a bag of plastics material. The food product which is not yet cooked is inserted in a bag of plastics material at ambient temperature or a refrigerating temperature.

The bags have to comply with some requirements, including:
they have to be adapted to food use (they must not release substances which are dangerous for health),
they have to withstand the pressure produced by the reduced pressure during the step of the production thereof,
they have to withstand the temperature both during the optional cooking step and for the entire duration of the conservation,
they have to be weldable or provided with a valve, to which it is possible to apply the pressure reduction and which is capable of maintaining it for the entire conservation step,
they must not be permeable to oxygen and only slightly permeable or not permeable to water at all.

In a second method, the container may be, for example, a pan or may more simply have a cylindrical shape, similar to that of a pot and may be made of metal, glass or plastics material.

In accordance with the type of food product to be cooked, there may be two cases:
1) the food product is cooked inside the container which may or may not have the cover and the reduced pressure is applied after it has been cooked;
2) the food product is inserted in the uncooked state in the container and the reduced pressure is applied, as in the bag, before the food is cooked.

The container has to comply with some requirements, including:
it has to withstand the degree of reduced pressure to which there is provision to subject it and the cooking and conservation temperature,
it has to be provided with a cover which withstands the degree of reduced pressure provided for and a valve, to which the reduced pressure is intended to be applied and which then has to be closed in order to maintain it, and with the possibility of being opened at the end of the conservation period in order to break the reduced pressure seal and to carry out the opening of the cover. Furthermore, the cover has to be provided with a seal (generally produced from silicone material) in order to produce the fluid-tightness with the container once the reduced pressure is produced.

With reference to the case in which the application of the reduced pressure is carried out after the food product has been cooked in the container, it is generally preferable for the reduced pressure to be applied to the container before the temperature of the food product is lowered to a value less than 58° C. and then it is immediately inserted into the conservation apparatus. The temperature is thereby prevented from being reduced to a range in which it is possible for bacteria to proliferate. This is one of the advantages of the method of conservation in the hot state.

Systems are known for the production of the pressure reduction on the basis of vacuum pumps (for example, piston pumps or vane pumps, lubricated or non-lubricated). These systems are used to produce a specific degree of pressure reduction, including a very great pressure reduction (for example, by reaching pressures of a few millibar) inside the containers. Since the food product is present inside the containers and this food product always has a substantial water content, and often also a very high water content, the physical limit at which the pressure of the air is successfully reduced is the vapour pressure of the water at the temperature of the food product.

For example, the following values of the vapour pressure of the water at some temperatures may be considered:

| Water temperature | Water vapour pressure |
|---|---|
| (° C.) | (mbar) |
| 20 | 23 |
| 40 | 74 |
| 60 | 200 |
| 80 | 473 |

The pressure reduction generation pumps, as prescribed by the manufacturers thereof, cannot operate with excessively hot foods, for example, with food products which have temperatures greater than 60° C., not because of the degree of reduced pressure which is limited by the vapour pressure of the water which at 60° C. is 200 mbar, but because at these temperatures during the pressure reduction step there is a high level of water evaporation and organic substances which then begin to condense on the rather cold surfaces of the pipes and/or the filters and/or the valves and/or inside the vacuum pump, creating problems of clogging, lubrication and possible bacterial contamination.

As a result of these evident limitations, there are not yet known nowadays applications which provide for the production of the pressure reduction in containers which contain cooked food products which are at temperatures greater than 58° C.

### DESCRIPTION OF THE INVENTION

A main object of the present invention is to provide a method for conserving cooked food products, which is configured to overcome the limitations set out with reference to the cited prior art.

This object and other objects which will be appreciated below are achieved by the invention by means of a method for conserving hot food products according to the appended claims.

According to a main aspect of the invention, a method for conserving cooked food products, wherein the food products are contained inside conservation containers having a total volume which is partially occupied by the food product and partially occupied by air in contact with the food product, comprises the steps of:
reducing the concentration of oxygen in a container which contains a cooked food product and in which the temperature of the cooked food product after the cooking is between 58° C. and 100° C., by means of the application of the reduced pressure generated by an ejector device which operates with compressed air so as to bring the concentration of oxygen to values less than 10%, within a duration time t2 including a first time period t1 in which the pressure in the container is brought to a value equal to the vapour pressure of the water contained in the food product and corresponding to the temperature of the food product, and maintaining this condition for a second successive time period t2−t1 so as to reach the oxygen concentration less than 10%,
sealing the container in order to prevent the introduction of oxygen and to maintain the concentration of oxygen reached in the preceding step,
conserving the sealed container which contains the cooked food product in an apparatus for conservation in the hot state at a predetermined temperature greater than 58° C. for a time not less than four hours.

### BRIEF DESCRIPTION OF THE DRAWINGS

The features and advantages of the invention will be better appreciated from the following detailed description of a preferred embodiment thereof which is illustrated by way of non-limiting example with reference to the appended drawings, in which:

FIGS. 1 and 2 are perspective views of respective examples of conservation containers for the food product which are suitable for the application of the conservation method of the invention,

FIG. 3 is a schematic, longitudinal section of an ejector device which is suitable for the application of the method of the invention,

FIG. 4 is a schematic side view of the device of FIG. 3,

FIG. 5 is a schematic side view of the device of FIG. 3 shown in combination with a food container of the type shown in FIG. 2, in an operating step of the conservation method of the invention,

FIG. 6 is a schematic partially sectioned view of a conservation device shown in combination with a food container, in a different step of the conservation method of the invention,

FIG. 7 is a schematic view of a construction variant of an ejector device which is suitable for the application of the method of the invention shown in combination with a compressed air supply line,

FIG. 8 is a graph, which shows an example of the progression over time of the degree of reduced pressure obtained during the application of the method of the invention.

### PREFERRED EXAMPLES OF THE INVENTION

With reference to the Figures cited, the conservation method according to the invention provides for a sequence of steps, with which a cooked food product C is subjected to conservation.

In a first step, there is provision for the food product C to be inserted inside a container which is generally designated 1. If the food product placed in the container has already been cooked (preferably, it is cooked in the same container), it passes to the subsequent step, in which the oxygen concentration is reduced. If the food product in the container has not already been cooked, it is possible to select application of the reduced pressure in order to reduce the oxygen concentration, as in the preceding case, and then to cook it or to cook it beforehand and then to apply the reduced pressure.

The conservation container 1 has a total volume which is partially occupied by the food product and which is partially occupied by air in contact with the food product.

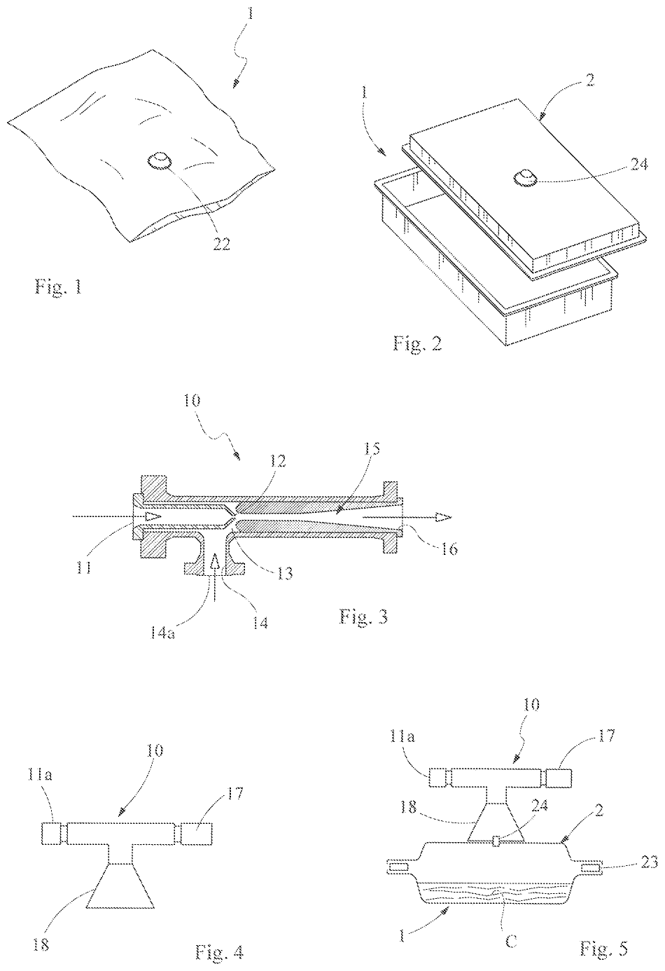

As will be extensively described below, the container 1 may have different formations, all suitable for the application of the method of the invention, for example, it may be a bag comprising plastics material (FIG. 1) or it may be a pan which has a substantially rigid structure and which is configured to be closed by a cover 2 (FIG. 2). In both cases, the container delimits therein a total volume which is occupied partially by the food product and partially by air in contact with the food.

Specific reference will be made below to the container 1 having the pan-like formation with a cover, but it will be understood that the method is also intended to be understood to be applicable when the container takes up the formation of a flexible bag of plastics material.

The food product C (already cooked or still to be cooked) which is inserted in the container 1 has, in general terms, a temperature which is at least greater than 1° C. For example, it may be at ambient temperature or a refrigerating temperature (if it has not already been subjected to cooking) or it may have a far greater temperature, taken up at the end of the cooking process, which must not in any case be less than approximately 58° C., so as to prevent deterioration as a result of the bacteriological action, before the conservation process (in this second case, the food product is preferably cooked in the same container).

A step of the method provides for initially reducing the oxygen concentration in the container 1 which contains the food product C having a temperature greater than at least 1° C., by means of application of the reduced pressure generated by an ejector device 10 which operates with compressed air so as to bring the volumetric oxygen concentration to values less than 10%, in a preferred manner less than 3%, in a further preferred manner less than 0.1%.

An example of an ejector device 10 which can be used to apply the reduced pressure in the container is shown in FIG. 3. It is of the type comprising an intake portion 11 for the flow of compressed air, from which a tubular portion which terminates with a nozzle 12 which is capable of accelerating the air flow conveyed in the ejector device extends. Downstream of the nozzle 12, there is provided a chamber 13 in communication with an intake pipe 14. At the chamber 13, there further extends a divergent pipe 15 which terminates with an outlet portion 16, through which the compressed air flow is discharged in a state mixed with the fluid drawn in through the pipe 14 as a result of the reduced pressure generated in the chamber 13 by the Venturi effect brought about by the passage of the compressed air flow through the nozzle (convergent portion) and the divergent portion of the ejector device.

A silencer member which may be provided downstream of the outlet portion 16 is designated 17.

A suction cup structure which is provided at the attachment portion of the intake pipe 14 and which is suitable for ensuring the connection of the ejector device to the container, with sealing in the intake zone for the air from the container, is designated 18.

A compressed air flow (the pressure of which may, for example, be selected in the range from 5 to 7 bar) is supplied to the ejector device 10 through the intake portion 11 (for example, by connecting this portion to a compressed air line) and generates a reduced pressure in the chamber 13 before being discharged from the outlet portion 16, drawing with it an air flow drawn in by the pipe 14 which is in communication with the chamber 13. Therefore, by connecting the attachment portion 14a of the pipe 14 to the closed container 1, it is possible to generate therein a specific degree of reduced pressure which depends on the characteristics of the ejector device (geometry and dimensions, in particular), the pressure and the compressed air flow which is introduced into the portion 11, and the application time of the reduced pressure.

It may be observed that one of the advantages of using an ejector device of the above-mentioned type for generating the reduced pressure in containers which contain cooked food at high temperatures (greater than 58° C.) is that, not having moving ejector members, there are no problems of lubrication and the potential problems of becoming soiled are limited: to the zone of the chamber 13 inside the ejector device in which the reduced pressure produced by the compressed air flow is generated,
to the pipe 14 where the reduced pressure is generated, to the divergent tubular outlet portion 15,
to the optional silencer 17 which is positioned downstream of the outlet portion 16.

The cleaning of the group composed of the ejector device 10, the silencer 17 (if present) and the suction cup 18 can readily be carried out, for example:
by placing the group in a dishwasher,
by washing the group by hand using detergents which are suitable for the purpose,
by causing the compressed air to flow from the attachment 11 and immersing the suction cup 18 in a receptacle which contains a solution of a liquid with a detergent and antibacterial action and by collecting the spray of liquid which is discharged from the outlet portion 16 or the optional silencer 17.

At the intake portion 11, there is further provision for the provision of an attachment 11a for connecting the ejector device to the compressed air line and for the attachment 11a to advantageously be a “quick-fit attachment”, that is to say, it can readily be detached without using particular tools, so that the operators employed in the kitchen can readily also remove it and can carry out the cleaning of the group by following the appropriate instructions supplied by the manufacturer.

Returning to the conservation method, during the step of reducing the oxygen concentration, the concentration is brought to values less than 10%, within a duration time t2 including a first time period t1 in which the pressure in the container is brought to a value equal to the vapour pressure of the water contained in the food product and corresponding to the temperature of the food product, and maintaining this condition for a second successive time period t2−t1 so as to reach the oxygen concentration less than 10%.

In a successive step with respect to the one in which the oxygen concentration has been reduced to the preselected value, there is provision for the container 1 to be closed and sealed in order to prevent the introduction of oxygen and to maintain the concentration of oxygen reached in the preceding step.

In an additional step, there is provision for optionally cooking the food product contained in the sealed container 1 if the food product has not already been cooked beforehand.

In an additional step, there is provision for conserving the sealed container 1 which contains the cooked food product in an apparatus for conservation in the hot state at a predetermined temperature greater than 58° C.

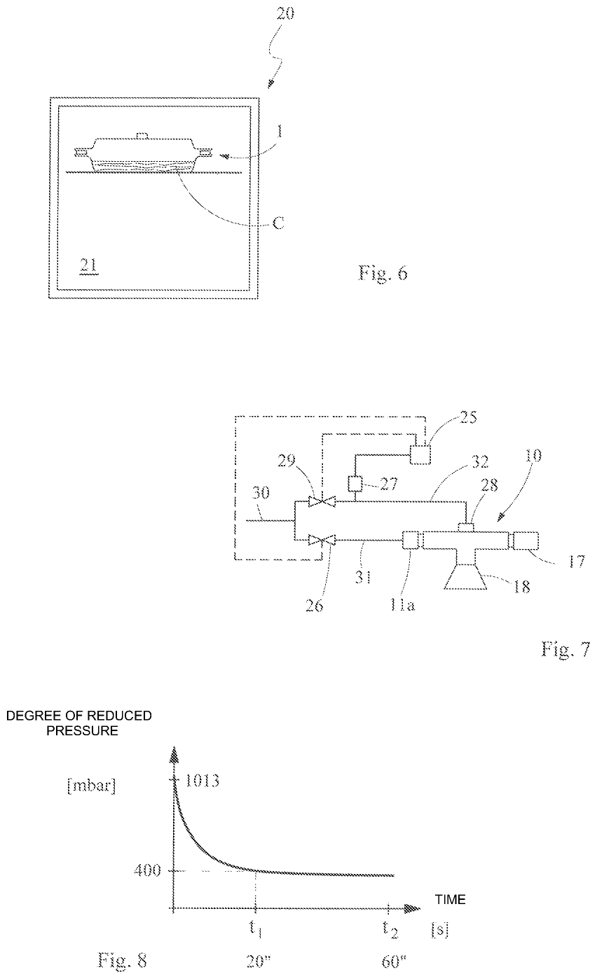

The conservation apparatus which is only schematically illustrated in FIG. 6 and which is designated 20 is provided with a conservation chamber 21 which is suitable for receiving one or more containers 1 and heat generation and distribution means for maintaining a preselected temperature inside the conservation chamber and optionally relative humidity (advantageous in the case of bags of plastics material which are permeable to the water vapour and which have to be conserved for a long time).

The sealed container 1 which contains the cooked food product is conserved in the conservation apparatus 20 for a time not less than several hours and preferably not less than four hours.

Therefore, if the food product is inserted into the container 1 in the state already cooked, the temperature of the food product after the cooking may advantageously be between 58° C. and, for example, approximately 100° C., and at this temperature the container will be inserted in the conservation apparatus in the hot state in order to be maintained at the preselected temperature imposed in the conservation apparatus (greater than 58° C.)

If the container is a bag of plastics material, the step of sealing the bag is advantageously carried out by means of thermowelding or by means of an integrated valve 22 which is suitable for generating and maintaining the reduced pressure in the bag.

If the container is formed in the manner of a pan with a respective closure cover, there is provision for the cover and/or the pan to be provided with a fluid-tight seal 23 which is suitable for ensuring the reduced pressure is maintained between the pan and cover during the step of generating the reduced pressure, during the possible subsequent cooking and during the subsequent conservation of the cooked food product in the hot state.

Furthermore, the cover 2 is provided with a valve 24 which is suitable for generating and maintaining the reduced pressure.

With reference to FIG. 5, there is provision for the ejector device 10 to be applied to the cover of the container by means of the suction cup 18 in such a manner that the valve 24 of the cover remains received inside the suction cup structure.

With regard to the ejector device 10, there is provision for the compressed air flow supplied thereto to be able to be controlled manually by the operator or by a control unit (which is schematically illustrated in FIG. 7 and designated 25).

In an embodiment, the control unit is configured to regulate the flow of compressed air by controlling a first solenoid valve 26 which is arranged upstream of the air intake portion 11 in the ejector device or by directly controlling an air compressor (not illustrated) which is provided to generate compressed air which is intended to be supplied to the ejector device. In this last case, the ejector device may be supplied with compressed air which is generated by an air compressor which is directly connected to the supply line of the ejector device without any need for using a tank for compressed air, if the compressor is selected by size so as to supply the optimum compressed air flow and pressure for the operation of the ejector device.

The use of a compressed air flow for producing the reduced pressure further has the advantage of mixing the water vapours and any possible organic substances which are drawn in by the container during the step of generating the reduced pressure with the compressed air, limiting or eliminating the problems of condensation of these vapours and helping to disperse them in the air. In fact, this water vapour or vapour of organic substances per se do not pose problems in the kitchen because they are the same vapours which are released from the container after cooking, but could pose great problems if concentrated because they could condense in contact with colder air or on the cold surfaces, and this is what happens if vacuum pumps were to be used, in line with the solutions of the prior art.

Another advantage which is involved in the generation of the reduced pressure when the cooked food product is at temperatures greater than 58° C., in addition to the advantage of not entering the bacterial proliferation range, is that during the pressure reduction process use is made of the production of water vapour evaporated from the food product in order to bring the oxygen concentration in the container to values which are far lower than the water vapour pressure. In fact, the production of vapour inside the container during the step of generating the reduced pressure has the effect of “washing” the volume of air present in the container, by continuously reducing the oxygen concentration for the entire duration of the application of the reduced pressure.

For example, there is used an ejector device which can achieve, as a result of the construction type thereof, a degree of pressure reduction of 100 mbar and a container which contains a cooked food product at a temperature of 80° C., with the ejector device being capable of obtaining an absolute pressure in the container, for example, of from 350 to 400 mbar which is slightly less, though not much less, than 473 mbar which is the vapour pressure of water at 80° C. This value, which is slightly lower than the vapour pressure, results from the cooling of the food product during the water evaporation process and the fact that the water in the food product is not present in a pure form. It may be considered that the quantity of water which has to evaporate in order also to obtain low values for oxygen concentration in a pan with a large volume is not very high and is limited to a few cubic centimetres of water. In fact, each cubic centimetre of water evaporated produces approximately 1 litre of vapour and a few litres of vapour are sufficient to “wash” the air in the container and to bring the concentration of the oxygen to very low values. If the pressure reduction step has a duration of, for example, 1 minute, at the end of the process of generating the reduced pressure it is possible to readily achieve values for oxygen concentration which are less than 0.1%. Naturally, the final value depends not only on the temperature of the food product and volume of the container, but also on the performance levels of the ejector device and the consumption of compressed air: for the same degree of reduced pressure which can be achieved, generally an ejector device which consumes more compressed air will draw in a greater air flow than one which is drawn in by an ejector device which consumes less air, with the final result of evaporating more water, therefore further “washing” and therefore lowering to a greater extent the concentration of oxygen.

In order to understand the advantage of the application of the reduced pressure with a hot food product, it may be considered that, if the container and the food product had been at a temperature of 20° C. (instead of 80° C.) and the reduced pressure had been generated at this temperature with the same ejector device, with the same pressure and flow of compressed air being introduced and for the same time, the effect of the evaporation of the water would have been negligible (at 20° C. the vapour pressure is only 23 mbar) and the final degree of reduced pressure would have been approximately 100 mbar (instead of from 350 to 400 mbar). However, there not having been a significant evaporation of water (and therefore no “washing”), the concentration of oxygen of the air in contact with the food product in the container would have been approximately 20.9×100/1013=2.1%, 20.9 being the volumetric percentage (%) of oxygen of atmospheric air, 100 mbar being the pressure reached at the end of the pressure reduction step and 1013 mbar being atmospheric pressure. An oxygen concentration of 2.1% instead of 0.1% in many cases would have greatly limited the conservation time in the hot state and probably would also have prevented the conservation thereof for times between a few hours and 24 hours.

Another aspect to be observed is that, if pans are used in order to cook the food product, it is necessary to use a sterilized cover in order to prevent the occurrence of contamination of the food product during the conservation step.

The sterilization may, for example, be carried out by inserting the cover inside the oven for an adequate time which depends on the temperature (which in any case has to be greater than or equal to 100°) or by using suitable sterilizing baths and/or liquids.

The pan also has to be sterilized before the food product to be cooked is inserted if the cooking of the food product is carried out at “low temperature”, for example, in the range between 70° C. and 90° C.

Should it be desirable to conserve food products both in a pan and in a bag and if bags filled with uncooked food product are being used, instead of using vacuum pumps as currently done for the bags, the ejector type system has the advantage of being able to use a single tool to generate the reduced pressure, whether using bags or containers of the pan type.

The parameters which influence the oxygen concentration which can be obtained at the end of the process of forming the reduced pressure are therefore:
type of food product,
quantity of food product,
temperature of the food product and the container,
type of container (example of pan and cover and therefore the volume thereof),
type of ejector device and particularly the degree of reduced pressure which it can reach,
pressure and flow of compressed air,
duration of the pressure reduction process.

Once all these parameters are fixed, in order to ensure that the desired oxygen concentration has effectively been reached, it would be necessary to measure it.

Directly measuring the oxygen concentration (for example, using Lambda probes) may be highly expensive and has an extremely large number of problems, for example, as a result of the delicate nature of the probe, the problems relating to the insertion and monitoring thereof and the difficulty of calibrating these sensors.

The progression of the degree of reduced pressure (absolute pressure) over time is a valid alternative to directly measuring the oxygen concentration because it may directly correlate with the oxygen concentration which there is at the end of the pressure reduction process once the above-mentioned parameters are fixed.

Therefore, one solution to the problem of ensuring that, at the end of the pressure reduction process, there has been reached a predetermined oxygen concentration, may be the one illustrated in FIG. 7, in which there is provision for using a pressure gauge 27 which measures the pressure in the zone of the chamber 13 which is substantially equal to the reduced pressure generated by the ejector device in the intake pipe 14.

In an embodiment, measuring the degree of reduced pressure is carried out manually by means of a pressure gauge of the analogue type. In an additional embodiment, measuring the degree of reduced pressure in the container is carried out by means of a pressure transducer, the transducer being connected to a control unit, for example, to the control unit 25, which is configured to process the pressure signal generated by the transducer.

There may further be provision for the time period of the application of the reduced pressure in the container to be in accordance with the degree of reduced pressure measured.

In an embodiment, the control of the time for generating the reduced pressure in the container provides for the following steps:
predetermining a minimum temperature of the food product in the container,
generating a predetermined degree of reduced pressure in a first predetermined time period,
further maintaining or reducing the degree of reduced pressure for a second predetermined time period.

The time periods for generating the reduced pressure and maintaining the degree of reduced pressure during operation of the ejector device may be controlled and decided by the operator, in the case of a manual measurement, or, alternatively, they may be controlled and decided by the control unit, if a pressure transducer which is operationally associated with the control unit is provided.

For example, with reference to the graph of FIG. 8 (which illustrates the degree of reduced pressure in accordance with time), a criterion may be to establish that the duration time t2 of the pressure reduction process is, for example, 60 seconds and that, within the time t1 of 20 seconds, a degree of reduced pressure of 400 mbar has to be reached and, in the remaining time t2−t1=40 seconds, the pressure continues to be less than 400 mbar.

With reference to FIG. 7, the ejector device 10 is further provided with a second attachment 28 of the quick-fit type for connection to an air line which carries the pressure signal to the gauge 27 so as to make the ejector device readily and rapidly removable from the line without using any particular tools so that the operators employed in the kitchen can also readily remove it and carry out the cleaning thereof.

The air line which connects the ejector device to the pressure gauge 27 is further connected to the compressed air network by means of a second solenoid valve 29.

FIG. 7 shows how the ejector device 10 is connected to a line 30 for the compressed air by means of a pipe 31 which has upstream the solenoid valve 26 which is capable of connecting it to the supply line 30 for the compressed air.

In order to generate the reduced pressure, it is necessary to position the suction cup 18 above the valve of the cover of the container or above the valve of the bag of plastics material (not shown in the Figures) or, in the case of bags of plastics material without any valve, on the attachment of the equipment used to generate the reduced pressure (generally a “bell-like member”) and to open the solenoid valve 26. The container starts to reduce the pressure thereof because the air therein is drawn off by the ejector device.

FIG. 7 also shows the solenoid valve 29 for connecting a pipe 32 of the line 30 for the compressed air to the line which is connected to the pressure gauge 27 and the zone of the chamber 13 of the ejector device 10. This solenoid valve 29 serves to cause cleaned compressed air to flow in the pipe 32 for a few seconds before the end of the pressure reduction step, thereby obtaining two results:
1) the pipe 32 is cleaned by discharging any droplets of condensation which may be formed during the step of forming the reduced pressure,
2) the suction cup 18 is removed by applying a specific pressure to the valve 24 which thereby rapidly closes hermetically.

In other words, there is provision for the solenoid valve 29 to be opened at the end of the step of generating the reduced pressure for a limited time (of a few seconds) so as to cause compressed air to flow in the pipe which connects the pressure gauge to the ejector device.

The invention thereby achieves the objects set out while affording the advantages set out with respect to the solutions of the cited prior art.

1. A method for conserving cooked food products, wherein the food products are contained inside conservation containers having a total volume which is partially occupied by the food product and partially occupied by air in contact with the food product, the method comprising the steps of:
reducing a concentration of oxygen in a container (1) which contains a cooked food product and in which the temperature of the cooked food product after the cooking is between 58° C. and 100° C., by application of a reduced pressure generated by an ejector device (10) which operates with compressed air so as to bring the concentration of oxygen to values less than 10%, within a duration time t2 including a first time period t1 in which the pressure in the container is brought to a value equal to the vapor pressure of the water contained in the food product and corresponding to the temperature of the food product, and maintaining this condition for a second successive time period t2−t1 so as to reach the oxygen concentration less than 10%,
sealing the container (1) in order to prevent the introduction of oxygen and to maintain the concentration of oxygen reached in the preceding step,
conserving the sealed container (1) which contains the cooked food product in an apparatus (20) for conservation in a hot state at a predetermined temperature greater than 58° C. for a time not less than four hours.

2. The method according to claim 1, wherein, during the step of reducing the oxygen concentration, the oxygen concentration is brought to values less than 3%.

3. The method according to claim 1, wherein, during the step of reducing the oxygen concentration, the oxygen concentration is brought to values less than 0.1%.

4. The method according to claim 1, wherein the container (1) is a bag made of plastics material.

5. The method according to claim 4, wherein the step of sealing the bag is carried out by means of thermowelding.

6. The method according to claim 4, wherein a valve (22) which is suitable for generating and maintaining the reduced pressure in the bag is integrated in the bag.

7. The method according to claim 1, wherein the container (1) is a pan which is provided with a closing cover (2).

8. The method according to claim 7, wherein at least one of the cover or the pan is/are provided with a fluid-tight seal (23) which is capable of ensuring the vacuum-tightness between the pan and the cover during the step of generating the reduced pressure, during the optional subsequent cooking and during the subsequent conservation of the cooked food product in the hot state.

9. The method according to claim 7, wherein the cover (2) is provided with a valve (24) which is suitable for generating and maintaining the reduced pressure.

10. The method according to claim 1, wherein the ejector device (10) is provided with a first attachment (11a) of the quick-fit type for connection to a compressed air line (30) so as to make the ejector device (10) removable readily and rapidly from the compressed air line.

11. The method according to claim 1, wherein the flow of compressed air which is supplied to the ejector device (10) is controlled by a control unit (25).

12. The method according to claim 11, wherein the control unit (25) is configured to regulate the flow of compressed air by means of control of a first solenoid valve (26) which is arranged upstream of an air intake portion (11) in the ejector device (10) or by means of directly controlling an air compressor which is provided to generate compressed air which is intended to be supplied to the ejector device.

13. The method according to claim 1, wherein measuring of the degree of reduced pressure generated in the container (1) is provided.

14. The method according to claim 13, wherein the measurement of the degree of reduced pressure is carried out manually by means of a pressure gauge (27) of the analog type.

15. The method according to claim 13, wherein the measurement of the degree of reduced pressure in the container (1) is carried out by means of a pressure transducer, the transducer being connected to a control unit which is configured to process the pressure signal which is generated by the transducer.

16. The method according to claim 14, wherein the duration time of the application of the reduced pressure in the container (1) is predetermined and, if the desired degree of reduced pressure is not reached within this time, the operation is not considered to have been successful.

17. The method according to claim 16, wherein the control of the time for generating the reduced pressure in the container (1) provides for the following steps:
predetermining a minimum temperature of the food product in the container (1),
generating a predetermined degree of reduced pressure in a first predetermined time period,
maintaining the degree of reduced pressure for a second predetermined time period.

18. The method according to claim 14, wherein the durations of the times for generating the reduced pressure and maintaining the degree of reduced pressure during the operation of the ejector device (10) are controlled and decided by the operator.

19. The method according to claims 15, wherein the durations of the times for generating the reduced pressure and maintaining the degree of reduced pressure during the operation of the ejector device (10) are controlled and decided by the control unit.

20. The method according to claim 14, wherein the ejector device is provided with a second attachment (28) of the quick-fit type for connection to an air line which carries the pressure signal to the gauge (27) so as to make the ejector device (10) removable from the line readily and rapidly.

21. The method according to claim 14, wherein the air line which connects the ejector device (10) to the pressure gauge (27) is connected to the network of compressed air by means of a second solenoid valve (29).

22. The method according to claim 21, wherein there is provision for the second solenoid valve (29) to be opened at the end of the step of generating the reduced pressure for a time of a few seconds so as to make compressed air flow in the pipe which connects the pressure gauge (27) to the ejector device (10).

23. The method according to claim 1, wherein the portion for drawing air into the ejector device is provided with a suction cup (18) for connecting the ejector device (10) to the container (1).

24. The method according to claim 1, wherein the ejector device (10) is supplied by compressed air which is generated by an air compressor which is connected directly to the supply line of the ejector device without a tank for compressed air being provided.

25. An apparatus for conserving cooked food products, comprising an ejector device (10) for applying the reduced pressure operating with compressed air and an apparatus for conservation in the hot state for conserving food products in containers (1) which are capable of being sealed after the generation of reduced pressure therein, operating according to the method of claim 1.

26. An apparatus for conserving cooked food products, comprising an ejector device (10), for applying reduced pressure, operating with compressed air and an apparatus (20) for conservation in the hot state for conserving food products in containers (1) which are capable of being sealed after the generation of reduced pressure therein, operating according to the method of claim 14, wherein the ejector device (10) is provided with an attachment (28) for connection to an air line which carries the pressure signal to the pressure gauge.
